(19) United States
(12) Patent Application Publication
(10) Pub. No.: US 2026/0296300 A1
(43) Pub. Date: Oct. 1, 2026

(54) CONTROL METHOD FOR ROAD PROJECTION DISPLAY AND DISPLAY CONTROL DEVICE

(71) Applicant: Nippon Seiki Co., Ltd., Niigata (JP)

(72) Inventors: Yusuke SAHARA, Niigata (JP); Midori WATANABE, Niigata (JP); Hanako HONMA, Niigata (JP)

(21) Appl. No.: 19/477,267

(22) PCT Filed: May 27, 2024
(86) PCT No.: PCT/JP2024/019369

§ 371 Date: Oct. 21, 2025

(30) Foreign Application Priority Data
May 29, 2023 (JP) 2023-088118

(51) Int. Cl. B60Q 1/24; B60Q 1/50; H05B 47/115

(52) U.S. Cl. CPC B60Q 1/247; B60Q 1/543; H05B 47/115; B60Q 2400/40

(57) ABSTRACT

Provided is a control method for road projection display, which, in a case of presenting some kind of information to an occupant at the time of getting in or out of a vehicle, is capable of performing display in a proper direction in accordance with the direction oriented toward the occupant approaching the vehicle without involving any sensors. In the control method for road projection display, in which an image is to be projected, by a road projector unit, onto a road surface around the opening of a lateral door of a vehicle, a projection control unit displays the road projection display such that the upper side of the display design is shown on the vehicle side upon detection of wireless unlocking from the ignition is in an OFF state while the vehicle is stopped.

### TECHNICAL FIELD

The present invention relates to a control method for road projection display that projects various kinds of information onto a road surface, and also relates to a display control device.

### BACKGROUND ART

A conventional projector is a device that projects and displays an image or a video onto a screen or the like. However, in recent years, a projector has been mounted on a headlight or a door of an automobile, which uses light to project a character, a pictogram, or the like onto a road surface (road projection) in a manner similar to projection mapping or the like, thereby performing a visual presentation. In addition, implementation of various functions has been studied as preventive safety, such as displaying a course of the own vehicle, a warning of door opening, and the like not only for a driver who drives an automobile but also for other traffic people such as pedestrians and cyclists. For example, Patent Document 1 discloses an image projection device including an acquisition unit that acquires information on a vehicle and an image projection unit that projects an image based on the information acquired by the acquisition unit, in order to enable various kinds of information to be projected and displayed on a road surface or the like, based on information on the vehicle, such as a traveling state of the host vehicle, and also discloses a passenger car that is equipped with the image projection device and projects image light from the image projection device to the front and rear of the host vehicle. In a passenger car equipped with the image projection device described in Patent Document 1, for example, an arrow, which is an image indicating a traveling direction of the host vehicle, is projected onto the road surface in front of the vehicle, based on a signal from a direction indicator sensor, and the arrow projected onto the road surface in front of the vehicle is flashed based on a traveling speed of the host vehicle, which is input from a vehicle speed sensor, and a steering angle of a steering wheel, which is input from a steering wheel steering angle sensor, thereby providing a more reliable presentation (warning) to surrounding drivers or pedestrians.

### PRIOR ART DOCUMENT

### Patent Document

Patent Document 1: Japanese Unexamined Patent Application Publication No. 2021-167197

### SUMMARY OF THE INVENTION

### Problems to be Solved by the Invention

However, in the vehicle equipped with the image projection device (road projector) described in Patent Document 1, although the arrow which is the image indicating the traveling direction of the host vehicle is projected onto the road surface, the image is not displayed in an orientation that makes it easy for the pedestrian to view, depending on the position of the pedestrian changes. In a vehicle equipped with such a road projector, when some information is presented to an occupant when boarding or disembarking the vehicle, there is an issue in that designs such as characters and pictograms are difficult to understand, because the orientation of the upper and lower portions as viewed by the occupant differs between when boarding and when disembarking. Further, for that reason, there has been a problem that adding high-precision sensors that detects the position of the occupant would increase the product price.

In view of the above-described problems, an object of the present invention is to provide a control method for road projection display, which is capable of performing display in an appropriate direction corresponding to a direction toward an occupant approaching a vehicle without using sensors in a case where some information is presented to the occupant when the occupant boards and disembarks the vehicle.

### Solution to Problem

A first aspect of the present invention is a control method for road projection display that projects an image onto a road surface around a door opening on a side of a vehicle by a road projector unit, the control method including, when radio unlocking is detected while the vehicle is stopped and an ignition is in an OFF state, by a projection control unit, displaying a road projection display such that an upper side of a display design thereof is toward the vehicle side.

In a second aspect dependent on the first aspect, in a display direction in which the road projection display is displayed such that the upper side of the display design thereof is toward the vehicle side, when it is detected that an unlocked door is opened, the projection control unit displays the road projection display such that a lower side of the display design thereof is toward the vehicle side.

In a third aspect dependent on the second aspect, in a display direction in which the road projection display is displayed such that the lower side of the display design thereof is toward the vehicle side, when it is detected that the unlocked door is opened, the projection control unit displays the road projection display such that the upper side of the display design thereof rotates gradually as time elapses.

In a fourth aspect dependent on the second aspect, in a display direction in which the road projection display is displayed such that the lower side of the display design thereof is toward the vehicle side, the projection control unit displays the road projection display linked to an in-vehicle display device such that the upper side of the display design of the road projection display is toward the vehicle side without changing a display orientation even when the door is opened.

A fifth aspect of the present invention is a control method for road projection display that projects an image onto a road surface around a door opening on a side of a vehicle by a road projector unit, the control method including, when the vehicle is fed with power or refueled, by a projection control unit: determining a position of an occupant based on a position of a power feed unit or a fuel filler port of the vehicle; determining, in advance, upper and lower portions of a display design of a specific road projection display indicating power feed or refueling; and displaying the road projection display.

A display control device according to a sixth aspect is a display control device that controls a road projector unit projecting a road projection display onto a road surface around a door opening on a side of a vehicle, the display control device including a processor that when radio unlocking is detected while the vehicle is stopped and an ignition is in an OFF state, displays the road projection display such that an upper side of a display design thereof is toward the vehicle side.

In the display control device according to a seventh aspect dependent on the sixth aspect, in a display direction in which the road projection display is displayed such that the upper side of the display design thereof is toward the vehicle side, when it is detected that an unlocked door is opened, the processor displays the road projection display such that a lower side of the display design thereof is toward the vehicle side.

In the display control device according to an eighth aspect dependent on the sixth or seventh aspect, in a display direction in which the road projection display is displayed such that the lower side of the display design thereof is toward the vehicle side, when it is detected that the unlocked door is opened, the processor displays the road projection display such that the upper side of the display design thereof rotates gradually as time elapses in the same rotational direction as a direction in which the door rotates about an opening axis thereof for a certain period of time.

In the display control device according to a ninth aspect dependent on the sixth to eighth aspects, in a display direction in which the road projection display is displayed such that the lower side of the display design thereof is toward the vehicle side, the processor displays the road projection display linked to an in-vehicle display device such that the upper side of the display design of the road projection display is toward the vehicle side without changing a display orientation even when the door is opened.

A display control device according to a tenth aspect, which may be dependent on the sixth to ninth aspects, is a display control device that controls a road projector unit projecting an image onto a road surface around a door opening on a side of a vehicle, the display control device including a processor that when the vehicle is fed with power or refueled: determines a position of an occupant based on a position of a power feed unit or a fuel filler port of the vehicle; determines, in advance, upper and lower portions of a display design of a specific road projection display indicating power feed or refueling; and displays the road projection display.

### Effect of the Invention

According to the present invention, in a case where some information is presented to an occupant when the occupant boards or disembarks a vehicle, the information can be displayed in an appropriate direction corresponding to the direction toward the occupant approaching the vehicle without using additional sensors.

### BRIEF DESCRIPTION OF THE DRAWINGS

FIG. 1 is a view of a road projection illustrating an embodiment of the present invention.

FIG. 2 is a view illustrating a state in which a conventional road projection display is turned upside down with respect to an occupant.

FIG. 3 is a view illustrating a state in which, when the vehicle is unlocked from an IGN OFF state while stopped, a road projection display design is displayed such that an upper side thereof is toward a side of a vehicle.

FIG. 4 is a view illustrating a state in which an unlocked door is opened and the road projection display design is displayed such that a lower side thereof is toward the vehicle side.

FIG. 5 is a view illustrating a state in which, while an unlocked door is being opened and closed, the upper side of the display design is rotated about an opening axis of the door and displayed.

FIG. 6 is a view illustrating a state in which a display content linked to an in-vehicle display device is displayed as it is without changing a display orientation.

FIG. 7 is a view illustrating a state in which a specific display content, such as refueling or charging, is displayed with upper and lower portions of the display design determined in advance based on a position of a fuel filler port or a charging unit of the vehicle.

FIG. 8 is a diagram explaining a configuration of a road surface projection system according to the present invention.

### MODE FOR CARRYING OUT THE INVENTION

Hereinafter, embodiments of the present invention will be explained in detail with reference to the drawings.

A road surface projection system that executes a control method for road projection display according to the present invention is mounted on a vehicle, and projects various kinds of information around the vehicle (for example, on a road surface around a door opening on a side of the vehicle).

First, a configuration of the road surface projection system that executes a control method for road projection display according to the present invention will be explained.

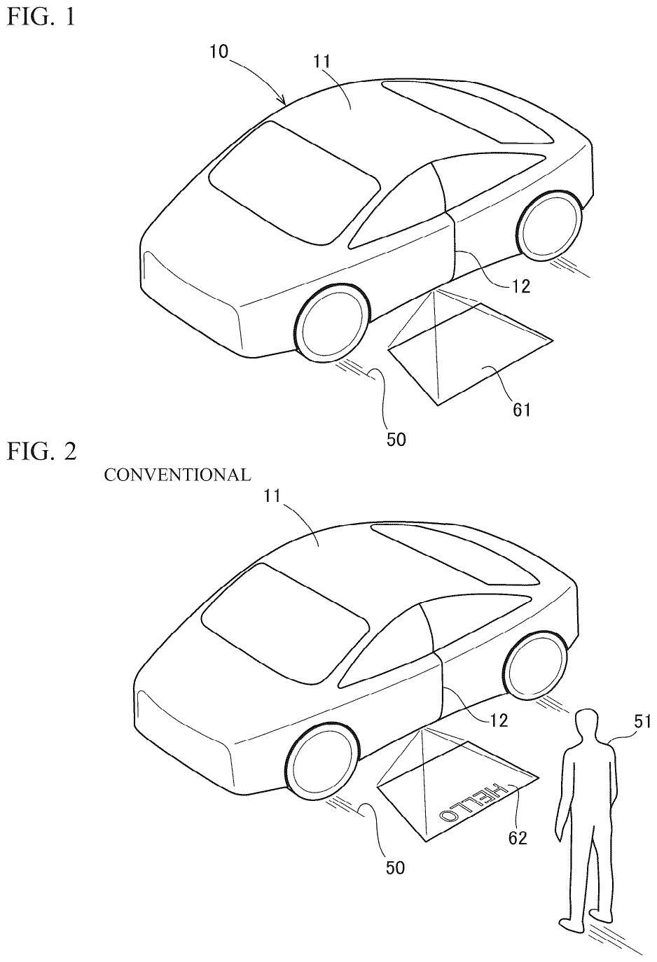

FIG. 1 and 3 to 7 illustrate respective examples of embodiments of the present invention, and FIG. 8 is a diagram for explaining a configuration of the road surface projection system according to the present invention.

As illustrated in FIGS. 1 and 3 to 8, a road surface projection system 10 according to the present invention is mounted on a vehicle 11, and includes a detection unit 20, a projection control unit (display control device) 30, and a projection unit 40.

The detection unit 20 includes an ignition (IGN) 21 as a power switch for turning on an ignition device of an engine or a power feed of a drive motor, an unlocking signal reception unit 22 that detects radio unlocking by a smart key or the like, with respect to door lock (locking) of the door 12 provided in the vehicle 11, a door opening/closing detection unit 23 that detects opening/closing of the door 12, and a power feed unit 24 (or a fuel filler port) of a battery.

The projection control unit 30 controls a display content and a display orientation (projection state) of the road projection display (road projection image plane) by the projection unit 40, based on a signal detected by the detection unit 20. Specifically, the function of the projection control unit 30 is achieved, for example, by a processor such as a CPU mounted on the vehicle 11 executing a program recorded in advance in a ROM.

The projection unit 40 projects various kinds of information onto the road surface 50 around the vehicle 11 (in the present embodiment, around a door opening on a side of the vehicle). The projection unit 40 includes an image generation unit 41 that generates an image to be projected, a road projector unit 42 that projects the generated image onto the road surface 50, and an in-vehicle display device 43 that projects the image into the vehicle 11.

The image generation unit 41 generates an image to be projected onto the road surface 50, based on information detected by various sensors mounted on the vehicle 11. The function of the image generation unit 41 is achieved, for example, by executing a program recorded in advance in the projection control unit 30 mounted on the vehicle 11. The road projector unit 42 and the in-vehicle display device 43 in the vehicle are constituted by, for example, a liquid crystal projector or other projectors.

FIG. 1 is a road projection view illustrating the embodiment of the present invention.

As illustrated in the drawing, a road projection display (road projection image plane) 61 is projected from the projection unit 40 (refer to FIG. 8) of the vehicle 11. The road projection display 61 is displayed around an opening of the door 12 on a side of the vehicle 11.

FIG. 2 is a view illustrating a state in which a conventional road projection display is turned upside down with respect to an occupant. As for an orientation of a conventional road projection display 62, when a position of an occupant 51 to be visually recognized is not sensed by a sensor, as illustrated in FIG. 2, a standing position of the occupant 51 does not align with the orientation of the display (the orientation of characters) in the road projection display 62.

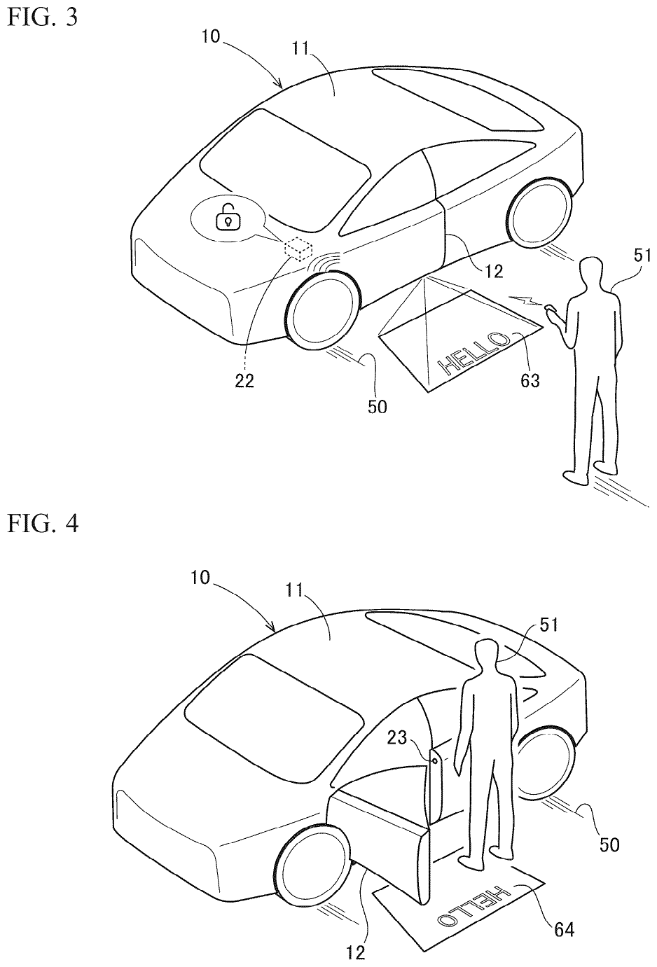

FIG. 3 is a view illustrating a state in which, when the vehicle is unlocked from an IGN OFF state while the vehicle is stopped, a road projection display design is displayed such that an upper side thereof is toward the vehicle side, in the embodiment of the present invention. In a control method for road projection display that projects an image onto a road surface around an opening of a door 12 on a side of a vehicle 11 by a road projector unit 42, when an unlocking signal reception unit 22 detects radio unlocking of the door 12, a projection control unit 30 displays the upper side of the display design toward the vehicle 11 side, similar to a road projection display 63 (for example, characters “HELLO”), thereby displaying information in a direction toward the occupant 51 approaching the vehicle 11.

In this way, by using the unlocking of the door 12 as a trigger, it is possible to perform display in an appropriate direction corresponding to the direction toward the occupant 51 approaching the vehicle 11 without using additional sensors.

FIG. 4 is a view illustrating a state in which an unlocked door is opened and the road projection display design is displayed such that a lower side thereof is toward the vehicle side. The control method for road projection display includes, in a state of a display direction in which the road projection display 63 (refer to FIG. 3) is displayed such that the upper side of the display design thereof is toward the vehicle 11 side, when the door opening/closing detection unit 23 detects an opening operation as a result of opening the unlocked door 12, the projection control unit 30 displays the lower side of the display design toward the vehicle 11 side, similar to a road projection display 64, based on the position of the occupant 51, thereby displaying information in a direction toward the occupant 51 standing in the vicinity of the door 12 of the vehicle 11.

In this way, by using the operation of opening the door 12 as a trigger to display the road projection display 64 such that the upper side of the display design is toward the vehicle 11 side, it is possible to perform display in an appropriate direction corresponding to the direction toward the occupant 51 who opens the door 12 of the vehicle 11 without using additional sensors.

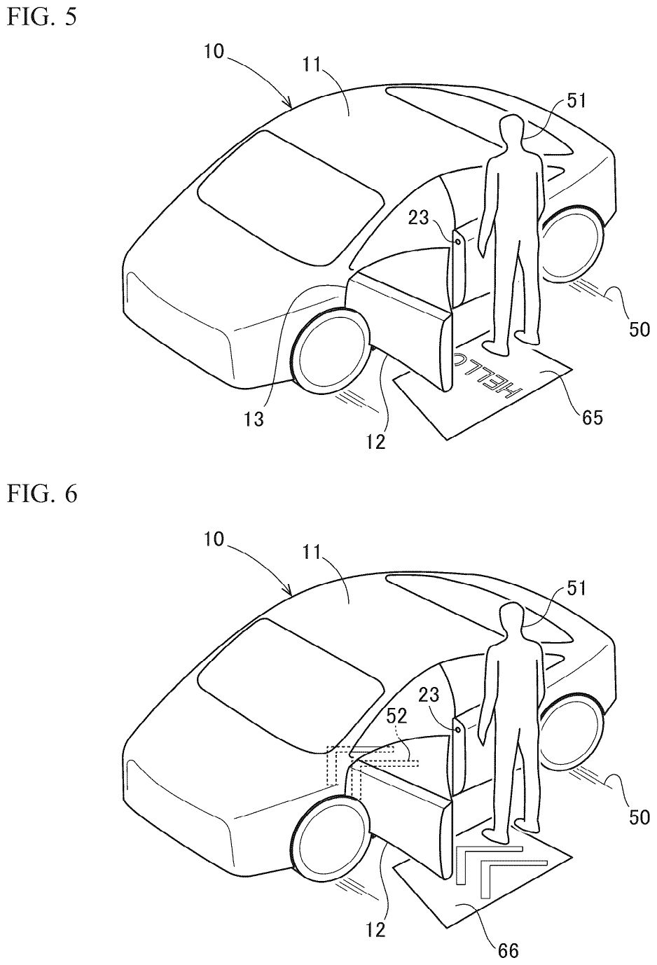

FIG. 5 is a view illustrating a state in which the display design is displayed such that the upper side thereof is oriented and rotated with respect to an opening axis of the door while the unlocked door is opened and closed. In the control method for the road projection display, in the state of the display direction in which the road projection display 64 (refer to FIG. 4) is displayed such that the lower side of the display design thereof is toward the vehicle 11 side, the projection control unit 30 displays a road projection display 65 such that an upper side of a display design thereof is oriented and rotated with respect to the opening axis of the door 12 for a certain period of time while the unlocked door 12 is opened and closed (open state).

In this way, by using the operation of opening the door 12 as a trigger, it is possible to perform display in an appropriate direction corresponding to the movement of the occupant 51 when the occupant 51 approaches the door 12 of the vehicle 11, opens the door 12, and boards the vehicle 11 without using additional sensors. The certain period of time for which the door 12 is kept open may be set to an any time such as 5 seconds, 10 seconds, or 20 seconds.

FIG. 6 is a view illustrating a state in which the display content linked to the in-vehicle display device is displayed as it is without changing the display orientation. In the control method for road projection display, in the display direction in which the road projection display 63 (refer to FIG. 3 for the display direction) is displayed such that the lower side of the display design thereof is toward the vehicle 11 side, the projection control unit 30 displays a road projection display 66 (for example, a symbol indicating the direction of travel) linked to an in-vehicle linked display 52 provided by the in-vehicle display device 43 such that the upper side of the display design of the road projection display 66 is toward the vehicle 11 side without changing a display orientation even when the door 12 is opened.

In this way, the occupant can feel a sense of linkage with the display in the vehicle (the in-vehicle linked display 52) by keeping the display orientation unchanged, with respect to the content linked to the in-vehicle display device 43 without using additional sensors.

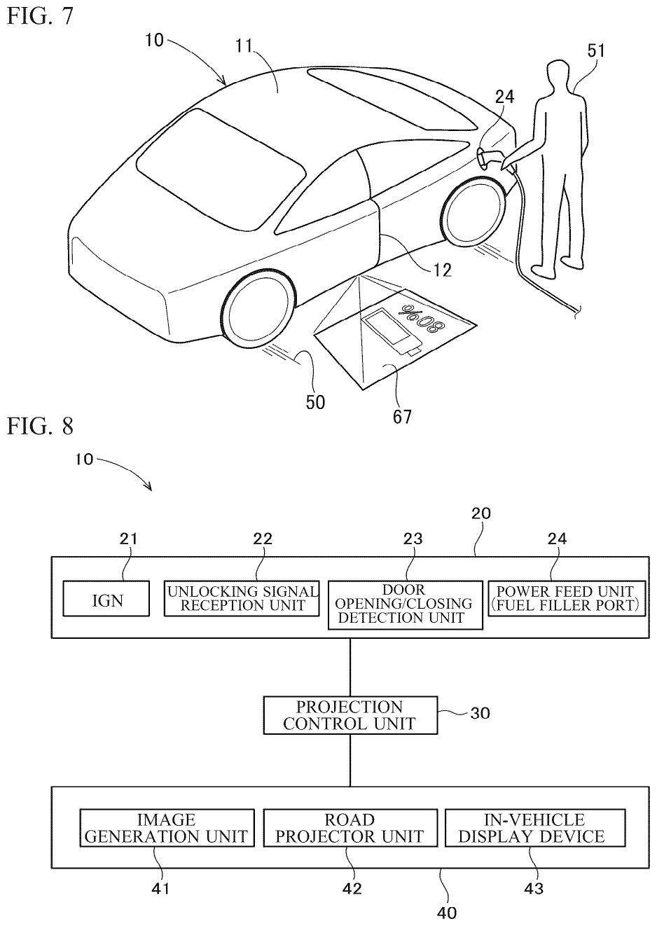

FIG. 7 is a diagram of a state in which a specific display content, such as refueling or charging, is displayed with the upper and lower portions of the display design determined in advance based on the position of the fuel filler port or the charging unit of the vehicle. In the control method for road projection display, when the vehicle detects a power feed state upon the vehicle 11 being fed with power or refueled, the projection control unit 30 determines the position of the occupant 51 based on the position of the power feed unit (or the fuel filler port) 24 of the vehicle 11, determines, in advance, upper and lower portions of a display design of a specific road projection display (display content) 67 indicating power feed or refueling, and displays the road projection display 67.

In FIG. 7, the road projection display 67 is displayed such that the lower side of the display design thereof is toward a side of the power feed unit (or the fuel filler port) 24.

In this way, by using the operation of power feed as a trigger, it is possible to perform display in an appropriate direction corresponding to the specific display content 67, such as power feed, without using additional sensors.

As described above, in the above-described control method for road projection display, when some information is presented to the occupant during boarding or disembarking the vehicle, the information can be displayed in an appropriate direction corresponding to the direction toward the occupant approaching the vehicle without using additional sensors.

The display contents of the road projection displays 61, 63, 64, 65, 66, and 67 may be characters other than HELLO or symbols other than the symbol indicating the direction of travel. In addition, sizes (ranges) of the road projection displays 61, 63, 64, 65, 66, and 67 to be projected may be fixed or variable.

In the embodiment of the present invention, the road projection display is projected onto the road surface 50 on the vehicle left side (passenger seat side). However, the present invention is not limited thereto, and the road projection display may be projected onto the road surface 50 on the vehicle left rear seat side, on the vehicle right front seat side (driver seat side), and on the vehicle right rear seat side.

In other words, as long as the functions and the effects of the present invention are achieved, the present invention is not limited to the embodiment.

### DESCRIPTION OF REFERENCE NUMERALS

10 Road surface projection system
11 Vehicle
12 Door
13 Opening axis of door
20 Detection unit
21 Ignition (IGN)
22 Unlocking signal reception unit
23 Door opening/closing detection unit
24 Power feed unit (fuel filler port)
30 Projection control unit (display control device)
40 Projection unit
41 Image generation unit
42 Road projector unit
43 In-vehicle display device
50 Road surface
51 Occupant
52 In-vehicle linked display
61, 63, 64, 65, 66, 67 Road projection display (road projection image plane)

1. A control method for road projection display that projects an image onto a road surface around a door opening on a side of a vehicle by a road projector unit, the control method comprising,
when radio unlocking is detected while the vehicle is stopped and an ignition is in an OFF state, by a projection control unit, displaying a road projection display such that an upper side of a display design thereof is toward the vehicle side.

2. The control method for road projection display according to claim 1, wherein
in a display direction in which the road projection display is displayed such that the upper side of the display design thereof is toward the vehicle side,
when it is detected that an unlocked door is opened, the projection control unit displays the road projection display such that a lower side of the display design thereof is toward the vehicle side.

3. The control method for road projection display according to claim 2, wherein
in a display direction in which the road projection display is displayed such that the lower side of the display design thereof is toward the vehicle side,
when it is detected that the unlocked door is opened, the projection control unit displays the road projection display such that the upper side of the display design thereof rotates gradually as time elapses in the same rotational direction as a direction in which the door rotates about an opening axis thereof for a certain period of time.

4. The control method for road projection display according to claim 2, wherein
in a display direction in which the road projection display is displayed such that the lower side of the display design thereof is toward the vehicle side,
the projection control unit displays the road projection display linked to an in-vehicle display device such that the upper side of the display design of the road projection display is toward the vehicle side without changing a display orientation even when the door is opened.

5. A control method for road projection display that projects an image onto a road surface around a door opening on a side of a vehicle by a road projector unit, the control method comprising,
when the vehicle is fed with power or refueled, by a projection control unit: determining a position of an occupant based on a position of a power feed unit or a fuel filler port of the vehicle; determining, in advance, upper and lower portions of a display design of a specific road projection display indicating power feed or refueling; and displaying the road projection display.

6. A display control device that controls a road projector unit projecting a road projection display onto a road surface around a door opening on a side of a vehicle, the display control device comprising
a processor that when radio unlocking is detected while the vehicle is stopped and an ignition is in an OFF state, displays the road projection display such that an upper side of a display design thereof is toward the vehicle side.

7. The display control device according to claim 6, wherein
in a display direction in which the road projection display is displayed such that the upper side of the display design thereof is toward the vehicle side,
when it is detected that an unlocked door is opened, the processor displays the road projection display such that a lower side of the display design thereof is toward the vehicle side.

8. The display control device according to claim 7, wherein
in a display direction in which the road projection display is displayed such that the lower side of the display design thereof is toward the vehicle side,
when it is detected that the unlocked door is opened, the processor displays the road projection display such that the upper side of the display design thereof rotates gradually as time elapses in the same rotational direction as a direction in which the door rotates about an opening axis thereof for a certain period of time.

9. The display control device according to claim 7, wherein
in a display direction in which the road projection display is displayed such that the lower side of the display design thereof is toward the vehicle side,
the processor displays the road projection display linked to an in-vehicle display device such that the upper side of the display design of the road projection display is toward the vehicle side without changing a display orientation even when the door is opened.

10. A display control device that controls a road projector unit projecting an image onto a road surface around a door opening on a side of a vehicle, the display control device comprising
a processor that when the vehicle is fed with power or refueled: determines a position of an occupant based on a position of a power feed unit or a fuel filler port of the vehicle; determines, in advance, upper and lower portions of a display design of a specific road projection display indicating power feed or refueling; and displays the road projection display.
